(19) United States
(12) Patent Application Publication
(10) Pub. No.: US 2016/0303407 A1
(43) Pub. Date: Oct. 20, 2016

(54) Worker Safety Device and Method

(71) Applicant: Enrico Galli, L'Orignal (CA)

(72) Inventor: Enrico Galli, L'Orignal (CA)

(21) Appl. No.: 15/092,823

(22) Filed: Apr. 7, 2016

(30) Foreign Application Priority Data
Apr. 17, 2015 (CA) 2888271

(51) Int. Cl. A62B 35/00; B60S 5/00

(52) U.S. Cl. CPC A62B 35/0068; A62B 35/0006; B60S 5/00

(57) ABSTRACT

A worker safety device for use with an object having a person support surface, the device comprising: a hinged device frame positionable on said object; a frame fastener coupled to the device frame configured to detachably fasten the device frame to the object; an attachment means, attached to the device frame, configured and positioned to attach a personal harness system to the device frame; whereby a person on said surface using the hinged device frame can prevent a fall from said surface by attaching the personal harness to the attachment means.

### FIELD OF THE INVENTION

This invention relates to the field of worker safety, and in particular, the field of devices and methods for improving worker safety.

### BACKGROUND OF THE INVENTION

In recent years, governments, businesses, and society at large have placed a progressively greater value on worker safety. Injuries to workers can be devastating to the injured workers themselves, their families, and their communities. The costs to businesses and governments associated with such injuries are also substantial. Such costs include the costs to businesses of insuring against the risk of liability for worker injuries. Meanwhile, it is usually government, and ultimately the taxpaying public, that bears the costs of caring for injured workers, particularly those that have suffered severe or catastrophic injury. For these and other reasons, businesses, governments and workers themselves striving to improve safety, including the optimization of work processes and methods, and the use of the most advanced safety-promoting equipment available.

Tractor-trailers (also known as truck-and-trailer, or semi-trailer trucks) are a common sight on North American highways. A tractor-trailer consists of a towing engine (“tractor”), and a trailer that carries freight. The trailer (also referred to as a “truck trailer” is attached to the tractor at the tractor's rear end, so that some fraction of the weight of the trailer is held up by the tractor, while the rest of the weight rests on the trailer's own wheels.

From time to time, it is necessary to perform repairs or routine maintenance on these trailers, requiring a repair person to climb onto the roof of the trailer. In winter, this routine maintenance can include removing snow from the roof. Climbing onto and working on the roof creates a safety hazard, namely, the risk that the worker will slip and/or fall off of the roof and suffer injury or death.

### SUMMARY OF THE INVENTION

Therefore, according to the present invention, there is provided a worker safety device for use with an object having a person support surface, the device comprising a hinged device frame positionable on said object; a frame fastener coupled to the device frame configured to detachably fasten the device frame to the object; an attachment means, attached to the device frame, configured and positioned to attach a personal fall arrest device to the device frame; whereby a person on said surface using the fall arrest device can prevent a fall from said surface by attaching the fall arrest device to the attachment means.

According to another aspect of the invention, there is provided a method of preventing a worker from falling off of a roof of a truck trailer, the trailer having first and second side rails, the method comprising the steps of: providing a worker safety device including a length-adjustable device frame, a first frame fastening element at a first end of the device frame, and a second frame fastening element at a second end of the device frame; fastening the frame to the trailer by (1) positioning the device frame in a pre-fastening position and (2) actuating a frame fastener to cause the frame fastening elements to fasten the device frame to the side rails; and attaching fall-preventing worker safety gear to the device to prevent a worker from falling.

### BRIEF DESCRIPTION OF THE DRAWINGS

Reference will now be made, by way of example only, to preferred embodiments of the invention and in which:

FIG. 1 is a perspective view of a worker safety device according to the present invention as shown on the roof of a truck trailer;

FIG. 2 is a top view of a worker safety device according to the present invention.

FIG. 3 is a perspective view of a worker safety device according to the present invention, as shown in use by a worker on the roof of a truck trailer.

FIG. 4 is a perspective view of a worker safety device according to the present invention, showing a worker after falling from the roof of a truck trailer.

FIG. 5a is a top view of the worker safety device according to the present invention;

FIG. 5b is a right side view of the worker safety device of FIG. 5a;

FIG. 5c is a left side view of the worker safety device of FIG. 5a;

FIG. 5d is a bottom view of the worker safety device of FIG. 5a;

FIG. 5e is a front view of the worker safety device of FIG. 5a;

FIG. 5f is a back view of the worker safety device of FIG. 5a;

### DETAILED DESCRIPTION OF THE PREFERRED EMBODIMENTS

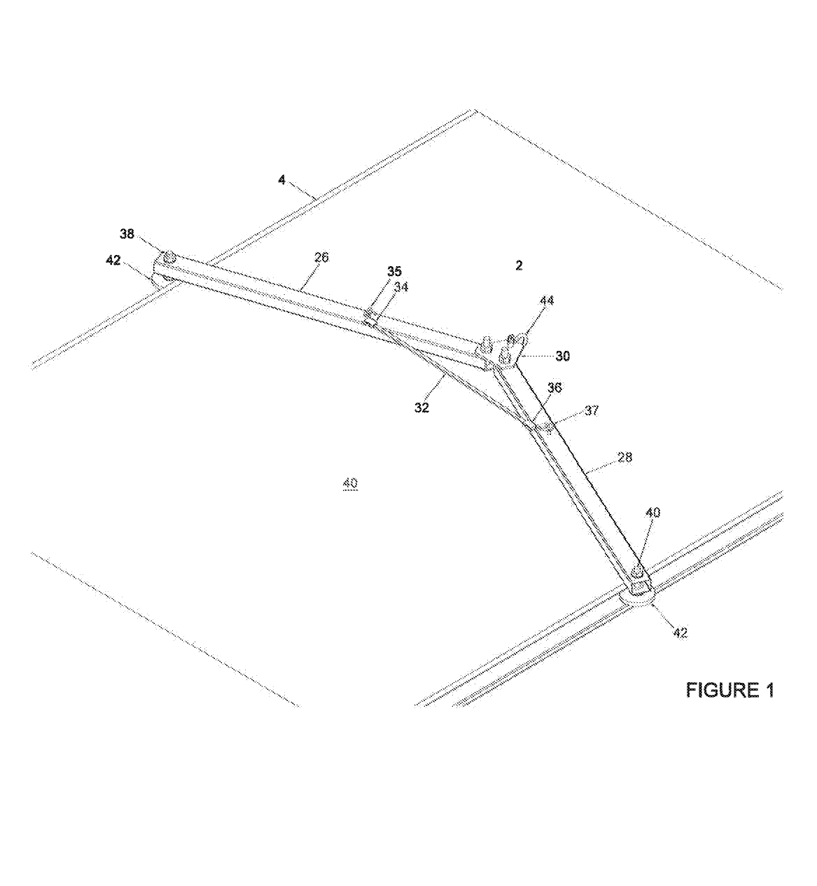

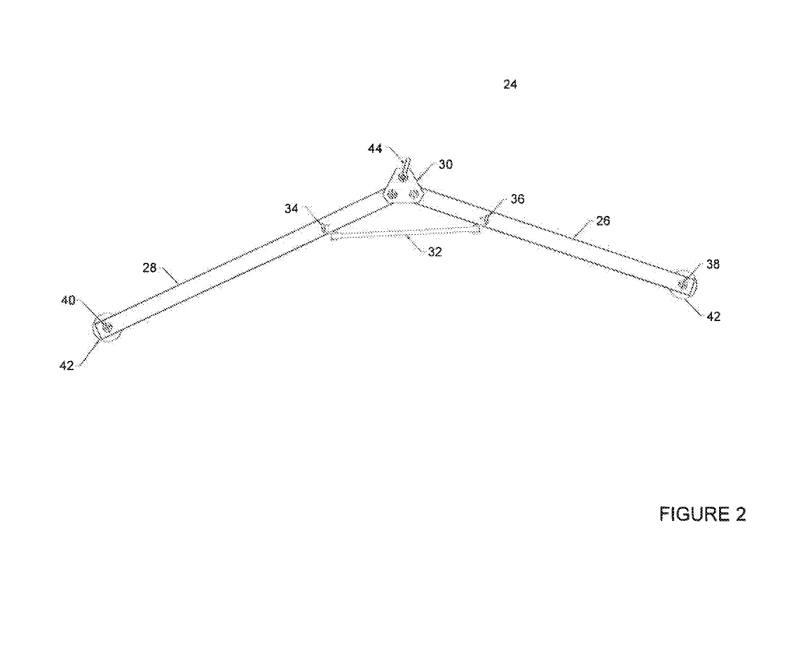

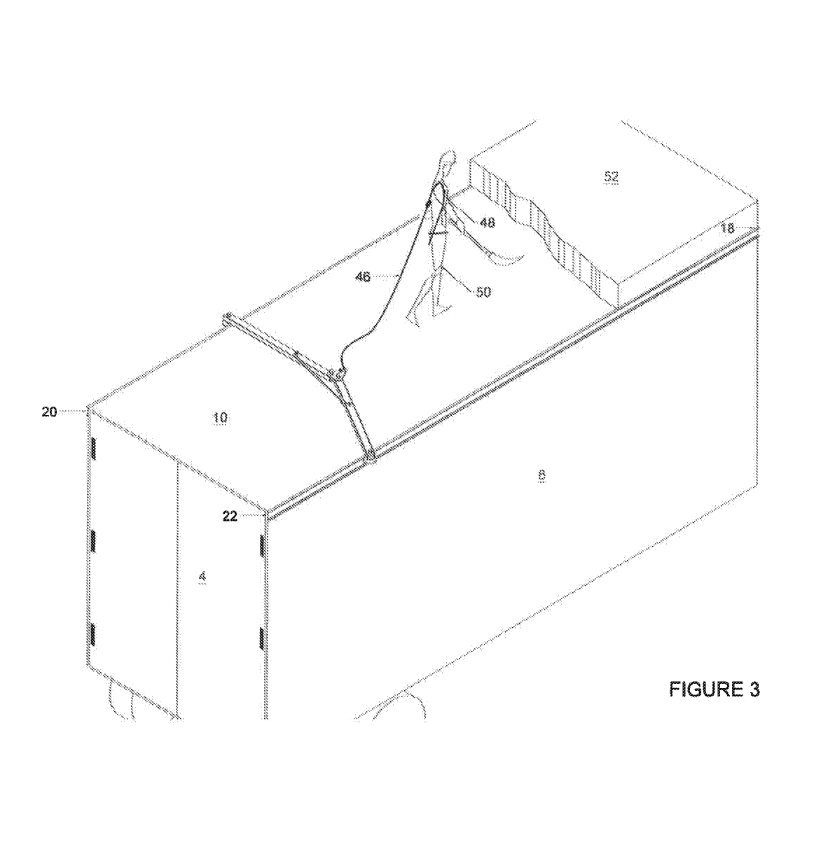

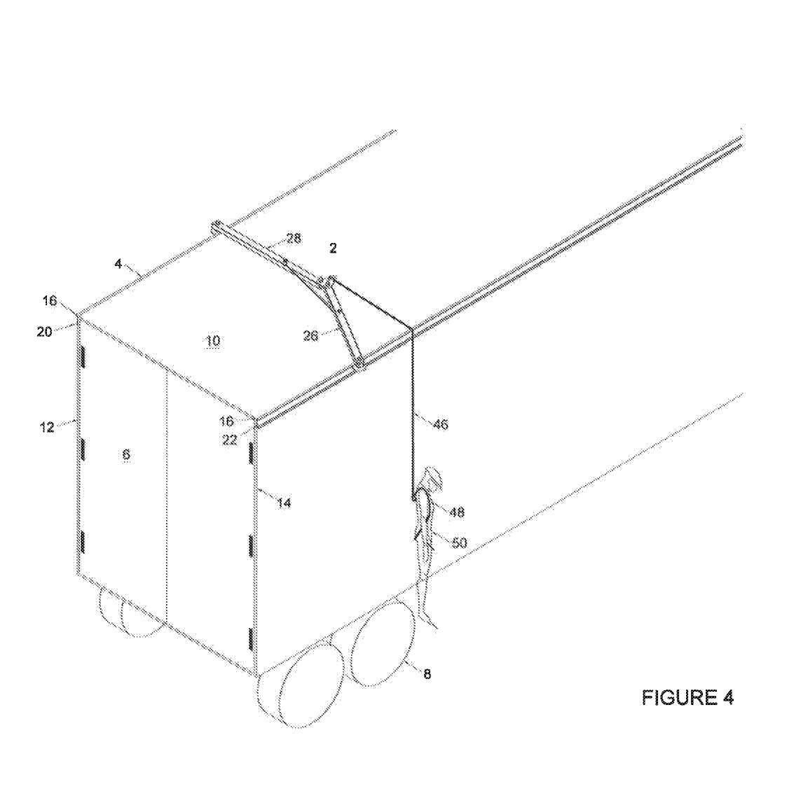

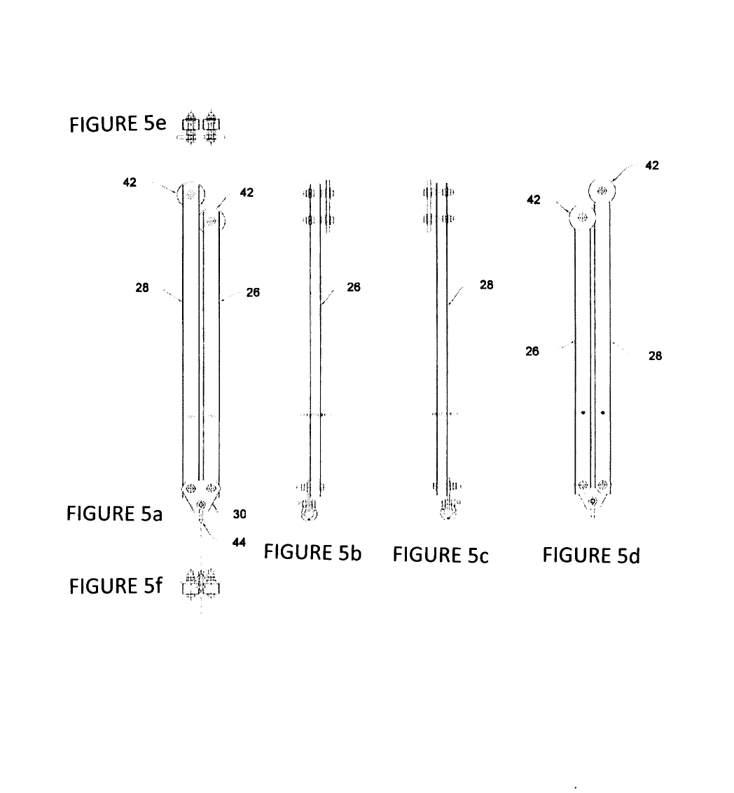

Referring now to FIGS. 1-4, the worker safety device 2 is shown. As shown in FIG. 3, the device 2 is preferably positioned on an object, typically a truck trailer 4. Trailer 4 comprises trailer body 6, supported by trailer wheels 8. Trailer 4 further comprises roof 10, and sides, preferably in the form of first and second side walls 12, 14. At the intersection between roof 10 and each side wall 12, 14 is a side edge of roof 10. Typically, at each of the two side edges of roof 10, there is a roof rail (16, 18) running along substantially the entire length of the trailer body 6, from the back of the trailer to the front. Also on the side walls of the typical trailer body 6, adjacent to each rail 16, is a rail indentation (20, 22), generally located immediately below rail 16. Some trailers have no such indentation, but commonly, the rail 16 protrudes outward beyond the portion of the wall (12, 14) immediately adjacent to rail 16, providing a geometry that facilitates the fastening of the device 2 to the rails 16, 18.

It will be appreciated that the invention may be used on a variety of objects, including, without limitation straight trucks.

An embodiment of the worker safety device 2 is shown at FIGS. 1-4. The device 2 comprises a hinged device frame 24 positionable on the object, typically the trailer 4. It will be appreciated, as elaborated below, that the worker safety device 2 is preferably configured for use with an object, such as trailer 4, that has a person-support surface on which a worker might be located. In the case of truck trailer 4, that person-support surface would typically comprise roof 10, but it will be appreciated that a device in accordance with the present invention may be used with other objects where it is desired to protect worker safety.

As shown in FIG. 3, the device frame 24 is preferably positioned above the roof 10, with the sides 20, 22 of the trailer 4 extending downward from the roof 10.

In the embodiment shown in FIGS. 1-3, the frame 24 comprises a first elongate member 26 and a second elongate member 28. The members 26, 28 are preferably hingedly attached to one another by means of a joining plate 30, and are pivotally moveable relative to one another.

The device 2 further comprises an elasticized cord 32, such as a bungee, frame fastener, which is attached at one end to a first mid-point 34 of the first elongate member 26 and at the other end to a second mid-point 36 of the second elongate member 28. The elasticized cord 32 works bias the first elongate member 26 and second elongate member 28 together. In the process of fastening the frame 24 to the trailer 4, fastening elements 38, 40 (described in further detail below) are pulled against the side edges of the trailer, so as to grip rails 16, 18, and preferably engage indentations 20, 22. The frame 24 is thus fastened to trailer 4. To detach the frame 24, members 26, 28 and elements 38, 40 are pulled apart against the force of elasticized cord 32, thus releasing the grip of one or both of elements 38, 40 on the corresponding rail 16, 18.

It will be appreciated that apart from the preferred and alternate embodiments described herein, the invention comprehends other modes of frame fastener. What is important is that the fastener be configured to fasten the device frame to the object. Thus, for example, anything that functions to hold the frame 24 in place on the object could be a frame fastener. Preferably, though not necessarily, the device frame will be detachably fastened to the object, meaning that the frame fastener is selectively operable to fasten the frame to the object and detach the frame from the object. A further example of such a frame fastener would be selectively engageable and disengageable suction cups attached to the frame, configured to fasten the frame to the object when engaged, and detach the frame when disengaged.

It will be appreciated that the fastening may be accomplished by means other than the gripping of rails 16, 18. For example, other parts of trailer 4 may be gripped. Or, a mode of fastening other than gripping may be employed. What is important is that the frame fastener be configured to fasten frame 24 to the object.

Preferably, the device 2 includes two wheel means attached to the device frame 24 and positioned so as to bear on sides 12, 14, so that the wheel means roll along the sides to facilitate movement of the device along the object. In the preferred embodiment, there is a wheel means associated with each of the fastening elements 38, 40, with each wheel means consisting of two wheels 42. Preferably, wheel means 42 are positioned and rotatably attached to each fastening element (38, 40). As can be seen in FIG. 3, wheels 42 are positioned so as to bear on respective sides 12, 14, and particularly, rails 16, 18.

It will be appreciated by those skilled in the art that the invention comprehends two types of locking, or fastening. First, the invention comprehends the use of the frame fastener to fasten the device frame 24 to the trailer body 6. The purpose of such fastening is to allow a person working on roof 10 to attach worker safety gear to the device 2 to prevent falling and injury. However, even with the frame 24 fastened to trailer body 6 by the frame fastener, it is still possible to move the device frame 24 along the length of trailer 6. This lengthwise or lateral movement along trailer 6 is important because it may be necessary for a worker to perform maintenance on one portion of the trailer, and then move safely to a different portion of the trailer and perform more maintenance there. Thus, in accordance with the present invention, a worker may fasten the device frame to trailer body 6 and perform work in the vicinity of the trailer adjacent to device frame 24. When it is desired to perform maintenance on a different portion of trailer body 6, the worker can push or pull device frame 24 along the length of trailer body 6 while the device frame 24 remains fastened to trailer body 6. This provides safety to the worker even as the worker moves the device frame 24.

It will be appreciated that the invention comprehends other means for facilitating lateral movement of the device frame 24 along trailer body 6 besides the wheel means referred to above. For example, the lateral movement facilitating means may include low friction sliders (not shown), consisting of low friction pads. Such pads would preferably be made of a low-friction material, and like the wheel means, are positioned so as to bear against sides 12, 14, and in particular indentations 20, 22. Whatever form the means for facilitating lateral movement may take, it will be appreciated that such means preferably include a low-friction interface between device frame 24 (preferably fastening elements 38, 40), and the trailer body 6, to allow for easy lateral movement of the device frame 24 along the trailer body 6.

On the other hand, it will be appreciated that while the capability for such lateral movement is preferred to permit movement for maintenance, repair, snow removal etc., and while having means for facilitating such lateral movement is preferred, the invention does not require the capability for such lateral movement. Rather, though not preferred, it is possible for a user to simply unfasten or detach the device 2 from the trailer body 6 when it is desired to move the device 2 along the length of the trailer body 6.

It will be appreciated that it is typical for fall-prevention safety equipment to include some kind of hook or carabiner which is meant to be attached to a fixed point to prevent a worker from falling. Therefore, the attachment means preferably comprises a hook-receiving element, most preferably in the form of ring 44. Preferably, as can be seen in FIGS. 1-3, the ring 44 is attached to the joining plate 30.

It will be appreciated that the attachment means may take other forms. It may be curved, and may have an open or closed shape. What is important is to provide a means for attaching a fall prevention device.

To use the device 8, a worker would fasten the device 2 to the trailer body 6. In the preferred embodiment, the worker climbing up to the roof 10 is initially positioned at one side of trailer 4. The worker positions device 2 in a pre-fastening position above roof 10. Preferably, the worker extends it across roof 10 so that the opposite end of device 2 (the opposite fastening element) grips the opposite rail. Then, the worker pulls the near side of the device 8, so that the near fastening element is positioned off roof 10. The adjacent fastening element is then gently released and elasticized cord 32 contracts to cause the near fastening element to grip the near rail. The device 2 and frame 24 are thus fastened to the trailer 4 by elasticized cord 32 to cause the fastening elements to fasten frame 24 to the side rails. Frame 24 can be removed or detached by pulling the near fastening element away from the opposite one against elasticized cord 32, releasing the near fastening element from gripping the near rail and then removing the device 2 from roof 10.

It will be appreciated that the invention comprehends other modes of actuating the frame fastener to cause the fastening elements to fasten frame 24 to the side rails. For example, a strap connecting the frame elements may be retracted to pull the fastening elements together to fasten the frame 24 to rails 16, 18.

After fastening, the worker would attach a fall arrest device or safety harness, to which he himself is attached, to ring 44. Then, in the event that the worker were to be in danger of falling (e.g. the worker trips or stumbles, and is about to fall off of roof 10), his fall arrest device would act as a brake. Meanwhile, the fall arrest device is attached to device frame 24, which is in turn fastened to trailer body 6, with the result that the worker would be prevented from falling off of roof 10 and to the ground, and would be saved from the attendant injury.

Preferably, the ring 44 is positioned approximately midway along the length of device frame 24, and thus, approximately equidistant from the sides 12, 14 when the device frame 24 is fastened to the trailer body 6. This positioning is preferred because it maximizes the area of roof 10 that a worker can reach while his fall-prevention gear is attached to ring 44.

It will be appreciated that the attachment of the ring 44 to the frame 24 at opposed ends 38, 40, though preferred, is not required. Other modes of attachment are comprehended by the invention. The above-described form of attachment is preferred because it has been found that having two widely distributed attachment points distributes the force on those attachment points, and on the device frame 24, in a beneficial manner in the event that a worker is falling and is thus exerting a force on the device frame 24. By having the ring 44 attached to the frame 24 at the opposed ends 38, 40, the force on the frame 24 acts at points adjacent to the fastening points of the device frame 24 to the trailer body 6. Thus, the amount of twisting force and torque applied to the device frame 24 is reduced, thus reducing the risk that the device would not operate properly.

Furthermore, distributing the points at which the attachment means is attached to the device frame 24 is beneficial, in that it is less likely that the attachment means will undesirably come off of the device frame 24.

It will further be appreciated that the attachment means may take other forms besides the embodiments described above. What is important is that the attachment means be attached to the device frame and be configured and positioned to attach the fall arrest device to the device frame.

The scope of the claims should not be limited by the preferred embodiments set forth in the examples, but should be given the broadest interpretation consistent with the description as a whole.

The embodiments of the invention in which an exclusive property or privilege is claimed are defined as follows:

1. A worker safety device for use with an object having a person support surface, the device comprising:
a device frame positionable on said object;
a frame fastener coupled to the device frame configured to detachably fasten the device frame to the object;
an attachment means, attached to the device frame, configured and positioned to attach a personal fall-prevention device to the device frame;
whereby a person on said surface using the fall-prevention device can prevent a fall from said surface by attaching the fall-prevention device to the attachment means.

2. A worker safety device as claimed in claim 1, wherein the object has first and second sides extending downward from said surface, and wherein said device frame is positionable above the person support surface and the frame fastener is configured to fasten the device frame to the sides.

3. A worker safety device as claimed in claim 2, wherein the device includes two wheel means attached to the device frame and positioned such that one wheel means bears on each side, and such that said wheel means roll along said sides to facilitate movement of said device along said object.

4. A worker safety device as claimed in claim 2, wherein the frame fastener includes a first fastening element for fastening the device frame to one of the sides and a second fastening element for fastening the frame to the other side.

5. A worker safety device as claimed in claim 4, wherein said device frame has first and second opposed ends, the first fastening element being positioned at the first end, the second fastening element being positioned at the second end.

6. A worker safety device as claimed in claim 3, wherein the frame fastener includes a first fastening element for fastening the device frame to the first side and a second fastening element for fastening the device frame to the second side, and wherein each of the wheel means is associated with one of the fastening elements.

7. A worker safety device as claimed in claim 2, wherein the device frame has first and second opposed ends, and includes a first fastening element positioned at the first end for fastening the device frame to the first side, and a second fastening element positioned at the second end for fastening the device frame to the second side, the device further including a first low-friction slider associated with the first fastening element so as to slide along the first side to facilitate movement of the device along the object, and a second low friction slider associated with the second fastening element to as to slide along the second side to facilitate movement of the device along the object.

8. A worker safety device as claimed in claim 1, wherein the frame fastener comprises a grip force generator configured to generate a force causing the device frame to grip the object.

9. A worker safety device as claimed in claim 8, wherein the frame fastener is coupled to the frame elements and configured to move the frame elements relative to one another so as to position said fastening elements to fasten the device frame to the object.

10. A worker safety device as claimed in claim 9, wherein said frame fastener comprises an elasticized cord attached to both frame elements, configured such that when the fastening elements are pulled apart, said spring applies a force to pull said fastening elements against the sides to grip the object.

11. A worker safety device as claimed in claim 9, wherein the frame fastener comprises a strap retractably attached to one of the frame elements and attached to the other frame element, and configured so that when the strap is retracted, the fastening elements are pulled against the sides to grip the object.

12. A worker safety device as claimed in claim 1, the attachment means comprising a hook-receiving element attached to the device frame.

13. A worker safety device as claims in claim 12, wherein the hook-receiving element comprises a ring.

14. A worker safety device as claimed in claim 13, wherein the ring is attached to both the first frame element and the second frame element adjacent the opposed ends of said device frame.

15. A worker safety device as claimed in claim 6, wherein the object comprises a truck trailer, the person support surface comprises a roof of said truck trailer, and wherein each of the sides includes a side rail running along the respective side adjacent the roof, the fastening elements being configured to fasten the device frame to the rails.

16. A method of preventing a worker from falling off of a roof of a truck trailer, the trailer having first and second side rails, the method comprising:
providing a worker safety device including a device frame, a first frame fastening element at a first end of the device frame, and a second frame fastening element at a second end of the device frame; fastening the frame to the trailer by:
positioning the device frame in a pre-fastening position;
actuating a frame fastener to cause the frame fastening elements to fasten the device frame to the side rails;
attaching fall-preventing worker safety gear to the device to prevent a worker from falling.

17. A method as claimed in claim 16, wherein the actuating step comprises retracting a strap to pull the fastening elements together to fasten the device frame to the rails.

18. A method as claimed in claim 16, wherein the actuating step comprises pulling the device frame against the force of an elasticized cord, and then releasing the device frame to actuate the elasticzed cord, wherein the elasticized cord urges the fastening elements to bear against and grip the rails.

19. A method as claimed in claim 16, wherein the attaching step includes attaching a safety harness worn by a worker to the worker safety device.
